(19) United States
(12) Patent Application Publication
(10) Pub. No.: US 2008/0262840 A1
(43) Pub. Date: Oct. 23, 2008

(54) Method Of Verifying Accuracy Of A Speech

(75) Inventors: Jesse Huang, Hsin-Tien City (TW); Jia-Fu Chen, Hsin-Tien City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: CYBERON CORPORATION, Hsin-Tien City (TW)

(21) Appl. No.: 11/849,440

(22) Filed: Sep. 4, 2007

(30) Foreign Application Priority Data
Apr. 23, 2007 (TW) 096114299

(51) Int. Cl. G10L 15/00

(52) U.S. Cl. 704/246; 704/E15.001

(57) ABSTRACT

A method for verifying the accuracy of speech is provided. The speech is pre-loaded into a dialog system. A medium is provided to verify the accuracy of the pre-loaded speech in the dialog system by comparing the test content with a predetermined speech script.

This application claims the benefit of priority based on Taiwan Patent Application No. 096114299 filed on Apr. 23, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

This invention relates to a method for verifying the accuracy of a speech. More particularly, this invention relates to a method for verifying the accuracy of a pre-loaded speech in a dialog system, by projecting the speech through a medium.

2. Descriptions of the Related Art

Speech recognition systems have played a role in many applications. In electronic products, users can enjoy more convenience in using such electronic products. For example, handsets with speech recognition functions can allow users to execute some operations using speech, such as activating functions, dialing phone numbers, or finding numbers of a certain person in the address books. Thus, there is no need to complete these operations via a complex operating interface.

However, for the speech recognition systems to operate properly, electronic products with such systems have to be verified for speech accuracy before shipping. Conventionally, actual human speech is used to verity accuracy of speech. Specifically, to verify consistency of the speech recognition systems, an operator has to repeat his own speech to test the recognition consistency of such systems in response to his own speech. Consequently, to verify the speech recognition system in an electronic product, the verification process has to be repeated uninterruptedly by the same operator. Obviously, such a verification method suffers from unsatisfactory consistency and high labor costs, and is also time-consuming.

Accordingly, it is highly desirable for the manufacturers of speech recognition systems to provide a method for verifying the accuracy of speech with improved verification consistency, as well as reduced labor and time.

### SUMMARY OF THE INVENTION

One objective of this invention is to provide a method for verifying the accuracy of a pre-loaded speech in a dialog system. According to this method, the accuracy of the speech in the dialog system is verified through a medium. This method completely removes the need of an actual human voice, and therefore can effectively improve the verification consistency and reduce labor and time.

This invention utilizes a pre-loaded speech script to verify the accuracy of speech in the dialog system by projecting the speech through a medium. Since the speech script and pre-loaded speech in the dialog system can be generated in the same manner, the inconsistency and disparity of the repeated human voice are effectively overcome, and a plurality of dialog systems can be verified at the same time using the same verification method and the same medium. As a result, not only labor and time are reduced, but also the application scopes of the verification technology are extended.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is diagram depicting the hardware configuration relationship of the preferred embodiment of this invention;

FIG. 2 is a flow diagram of the preferred embodiment of this invention; and

FIG. 3 is a flow diagram of a speech comparison using the present invention.

### DESCRIPTION OF THE PREFERRED EMBODIMENT

In the following descriptions, the present invention will be described in reference to the embodiments that verify the accuracy of speech. However, embodiments of the invention are not limited to any particular environment, application or implementation. Therefore, the following descriptions of the embodiments are for purposes of illustration and not limitation.

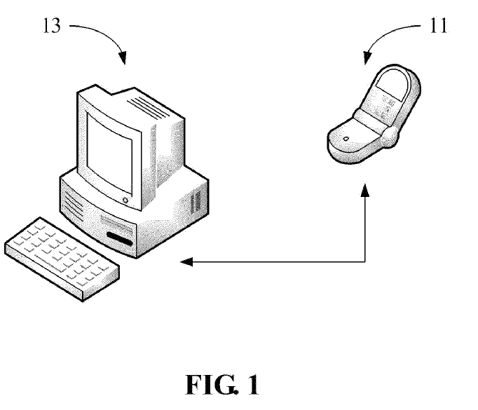

The preferred embodiment of this invention is illustrated in FIG. 1. The speech is pre-loaded into a dialog system, which, in this embodiment, is implemented in a handset 11. The dialog system can receive the speech from a user and recognize the user's speech based on the pre-loaded speech in the handset 11 to make a dialog. The pre-loaded speech in the handset 11 must be verified in factory before on board to the market in order to ensure good quality and desired functionality.

This invention uses a verification system 13 as a medium to verify the accuracy of a pre-loaded speech in the dialog system of the handset 11. The verification system 13 can be connected to the handset 11 through a wired or wireless link. The speech provided in the dialog system of the handset 11 may be pre-loaded using, for example, synthesis, wherein the pre-synthesis of the speech can be accomplished using a text-to-speech (TTS) technology that is not described in detail herein.

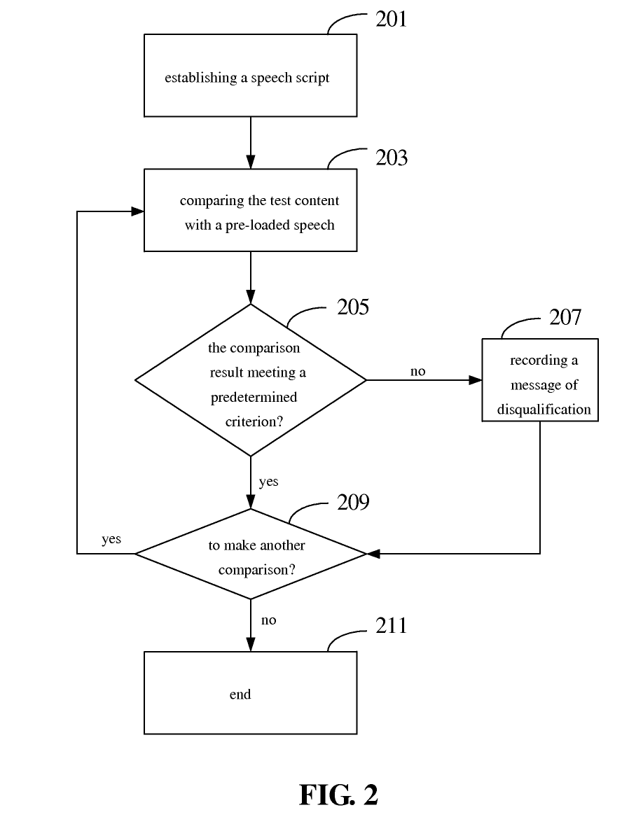

As shown in step 201 of FIG. 2, the verification system 13 establishes a speech script which comprises a speech database. The speech database contains a plurality of test contents which can be established using a conventional pre-recoding method or synthesized with the aforesaid TTS technology. The test content in the speech script corresponds to the pre-loaded speech in the handset 11. In step 203, the verification system 13 broadcasts the test content for comparison to the pre-loaded speech in the handset 11. The comparison between the test content and the pre-loaded speech are determined in step 205 to see whether the comparison achieve a predetermined criterion. For example, the predetermined criterion may either match the test content, or result in an error rate, in which the error rate falls below a predetermined threshold. If the comparison fails to meet the predetermined criterion, step 207 is executed to record a disqualification message. The verification then proceeds to the next phase. If the comparison result in step 205 meets the predetermined criterion, then step 209 is straightforwardly executed, in which the verification system 13 determines whether to compare the text content with another pre-loaded speech in the handset 11 for verifying the accuracy of another speech. If the determination is yes, then the process returns to step 203 to continue the comparisons; otherwise, step 211 is executed to terminate the process.

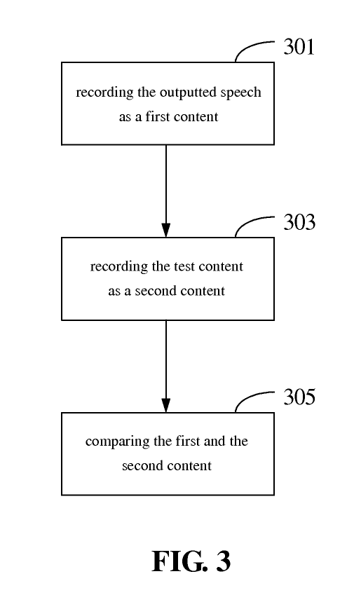

From the method described above, step 203, in which the test content is compared to the pre-loaded speech, is illustrated in more detail in FIG. 3. The additional steps are described as follows. In step 301, the verification system 13 outputs the speech in the handset 11 that corresponds to the test content and records the outputted speech as the first content. In particular, when the test content broadcasted by the verification system 13 is received, the handset 11 recognizes the test content corresponding to the pre-loaded speech via the dialog system and records the speech as the first content. Then, the handset 11 outputs the first content that represents the speech. The verification system 13 can receive and record the first content that represents the outputted speech of the handset 11 through a wired or wireless link. In step 303, the verification system records the test content that is broadcasted as the second test content. Next, in step 305, the verification system 13 compares the first content and the second content according to the predetermined criterion using the same method as described above and thus, will not be described again.

It should be noted that the first and second test contents may vary. For example, the first content may be a text that represents the outputted speech, while the second content may be a text that represents the test content. In this case, the verification system 13 compares the first content with the second content using the respective texts. In another example, the first content may be a code that represents the outputted speech, while the second content may be a code that represents the test content. In this case, the verification system 13 compares these two codes. Once again, the sequence of the various steps described above is not intended to limit this invention. For example, step 303 may be executed before step 301.

It is apparent from the above descriptions that, unlike conventional practices where real human voices are used to verify speech, this invention improves the verification accuracy and consistency, while also reducing the amount of labor. In this invention, a verification system operates to dynamically verify the accuracy of the pre-loaded speech in the dialog system and to simultaneously record the verification results. With faster verification, the rest of the manufacturing process can proceed accordingly, which also improves production efficiency. The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for verifying accuracy of a speech, wherein the speech is pre-loaded in a dialog system, the method comprising steps of:
(a) establishing a speech script, the speech script comprising a test content corresponding to the speech pre-loaded in the dialog system; and
(b) comparing the test content with the speech pre-loaded in the dialog system by broadcasting the test content via a medium.

2. The method as claimed in claim 1, wherein the step (a) further comprises step of:
(a-1) establishing a speech database, wherein the speech database comprises a plurality of test contents, and the speech script comprises the database.

3. The method as claimed in claim 1, wherein the step (b) comprises steps of:
(b-1) outputting the speech of the dialog system for recording the outputted speech as a first content;
(b-2) recording the broadcasted test content as a second content; and
(b-3) comparing the first content with the second content according to a predetermined criterion.

4. The method as claimed in claim 3, further comprising steps of:
(c) recording a message of disqualification and then proceed to a next phase of verification for the dialog system when the step (b-3) of comparing does not meet the predetermined criterion.

5. The method as claimed in claim 4, wherein the step (c) is executed to compare another text content with another speech pre-loaded in the dialog system for verifying the another speech by executing the step (b).

6. The method as claimed in claim 1, wherein the speech is pre-synthesized in the dialog system, and the speech script being established in the step (a) comprises a synthesized test content corresponding to the pre-synthesized speech of the dialog system.
